(19) United States
(12) Patent Application Publication
(10) Pub. No.: US 2026/0122192 A1
(43) Pub. Date: Apr. 30, 2026

(54) IMAGE READING APPARATUS

(71) Applicant: SEIKO EPSON CORPORATION, Tokyo (JP)

(72) Inventor: Kendai KAWAKAMI, KITAKYUSHU-SHI (JP)

(21) Appl. No.: 19/370,870

(22) Filed: Oct. 28, 2025

(30) Foreign Application Priority Data
Oct. 31, 2024 (JP) 2024-191548

(51) Int. Cl. H04N 1/00

(52) U.S. Cl. CPC H04N 1/00591; H04N 1/00602; H04N 1/00604; H04N 2201/0081

(57) ABSTRACT

An image reading apparatus includes a document conveyer that conveys a document to a reader. The document conveyer includes a discharger that discharges the document, and a stacker that forms a stacking surface on which the document discharged by the discharger is stacked. The stacking surface has a first inclining surface having an upward gradient along a discharge direction in which the document is discharged; and a second inclining surface located downstream from the first inclining surface in the discharge direction. The stacking surface is provided with a projection protruding upward from the stacking surface and extending along the discharge direction. The projection is so formed that the projection has an upward gradient along the discharge direction and extends throughout the first inclining surface and the second inclining surface.

The present application is based on, and claims priority from JP Application Ser. No. 2024-191548, filed Oct. 31, 2024, the disclosure of which is hereby incorporated by reference herein in its entirety.

### BACKGROUND

### 1. Technical Field

The present disclosure relates to an image reading apparatus that reads an image of a document.

### 2. Related Art

There is what is called a sheet-feeding, image reading apparatus that reads a document while conveying the document. Some image reading apparatuses of this type employ a configuration in which a document is sent from a document table on which a document before being fed is placed, the document is curved downward, the document is reversed, and the document is then discharged toward a discharged sheet tray located below the document table, as shown in JP-A-2024-038926. The document table described in JP-A-2024-038926 is hereinafter rephrased as a sheet feed tray.

The discharged sheet tray has a placement surface on which the document is placed that inclines in a way that the upstream portion in the discharge direction is lower than the downstream portion in the discharge direction. In other words, the placement surface inclines in a way that it has an upward gradient along the discharge direction. The discharged document therefore moves upstream in the discharge direction due to the inclination of the placement surface, and the rear end of the document hits a stopper surface. The rear ends of multiple documents on the discharged sheet tray are thus aligned with each other. The inclination of the placement surface further prevents a document discharged onto the discharged sheet tray from sticking out.

The inclination of the placement surface is technically significant as described above, and it is therefore preferable that the entire placement surface inclines. However, since the sheet feed tray is provided above the placement surface, the inclination of the entire placement surface may cause a decrease in visibility of a discharged document, or a decrease in easiness of picking up a discharged document. Therefore, in many cases, the downstream portion of the placement surface in the discharge direction is formed as a gently inclining portion.

JP-A-2024-038926 is an example of the related art.

When the downstream portion of the placement surface in the discharge direction is formed as a gently inclining portion, a discharge direction downstream portion of a discharged document bends downward, so that the discharged document is unlikely to return upstream in the discharge direction, resulting in deterioration of discharged document alignment in some cases. When the document discharge speed increases as the scanning speed increases, the deterioration of the document alignment becomes more remarkable.

To suppress the bending of a document described above, it is conceivable to improve the rigidity of the document by causing the document to curl when viewed in the discharge direction, but it is necessary in this case to employ a skillful mechanism that allows the discharged document to readily return upstream in the discharge direction.

### SUMMARY

An image reading apparatus of the present disclosure includes: a reader configured to read an image of a document; and a document conveyer configured to convey the document to the reader, wherein the document conveyer includes a discharger configured to discharge the document read by the reader, and a stacker configured to form a stacking surface on which the document discharged by the discharger is stacked, the stacking surface has a first inclining surface having an upward gradient along a discharge direction in which the document is discharged, and a second inclining surface located downstream from the first inclining surface in the discharge direction and having an upward gradient smaller than the upward gradient of the first inclining surface along the discharge direction, a stopper surface that a rear end of the document hits is provided upstream from the first inclining surface in the discharge direction, the stacking surface is provided with a projection protruding upward from the stacking surface and extending along the discharge direction, and the projection is so formed that the projection has an upward gradient along the discharge direction and extends throughout the first inclining surface and the second inclining surface.

### BRIEF DESCRIPTION OF THE DRAWINGS

FIG. 1 is an exterior perspective view of a document conveyance apparatus viewed from above.

FIG. 2 shows a document conveyance path in the document conveyance apparatus.

FIG. 3 shows projections viewed in a document width direction.

FIG. 4 shows the projections viewed in a document discharge direction.

FIG. 5 is a perspective view of the projections viewed from above.

FIG. 6A is a plan view of a stacking surface and the projections.

FIG. 6B is a plan view of the stacking surface and the projections.

FIG. 6C is a plan view of the stacking surface and the projections.

FIG. 7 is a plan view of projections according to another embodiment.

FIG. 8 is a plan view of projections according to another embodiment.

FIG. 9 is a side view of projections according to another embodiment.

### DESCRIPTION OF EMBODIMENTS

The present disclosure will be schematically described below.

An image reading apparatus according to a first aspect includes: a reader configured to read an image of a document; and a document conveyer configured to convey the document to the reader, wherein the document conveyer includes a discharger configured to discharge the document read by the reader, and a stacker configured to form a stacking surface on which the document discharged by the discharger is stacked, the stacking surface has a first inclining surface having an upward gradient along a discharge direction in which the document is discharged, and a second inclining surface located downstream from the first inclining surface in the discharge direction and having an upward gradient smaller than the upward gradient of the first inclining surface along the discharge direction, a stopper surface that a rear end of the document hits is provided upstream from the first inclining surface in the discharge direction, the stacking surface is provided with a projection protruding upward from the stacking surface and extending along the discharge direction, and the projection is so formed that the projection has an upward gradient along the discharge direction and extends throughout the first inclining surface and the second inclining surface.

The stacking surface has the first inclining surface and the second inclining surface having an upward gradient smaller than that of the first inclining surface. Therefore, when the front end of the discharged document sticks downstream in the discharge direction out of the first inclining surface, a front end portion of the discharged document bends downward, so that the document is unlikely to return upstream in the discharge direction, which may result in deterioration of the document alignment. The deterioration of the document alignment occurs due to the fact that the rear end of the document cannot return to the stopper surface.

According to the present aspect, the stacking surface is provided with the projection protruding upward from the stacking surface and extending along the discharge direction, and the projection is so formed that it has an upward gradient along the discharge direction and extends throughout the first inclining surface and the second inclining surface. As a result, even when the front end of the discharged document sticks downstream in the discharge direction out of the first inclining surface, the document can appropriately curl as described above, so that downward bending of a front end portion of the discharged document can be effectively suppressed. As a result, the discharged document can appropriately return upstream in the discharge direction, so that the deterioration of the document alignment can be suppressed.

A second aspect is an aspect according to the first aspect, in which a position at which a front end of a document having a first size arrives at a most downstream point in the discharge direction when the document is discharged is called a first arrival position, and the first arrival position falls within a range over which the projection is formed in the discharge direction.

According to the present aspect, a position at which the front end of the document having the first size arrives at the most downstream point in the discharge direction when the document is discharged is called the first arrival position, and the first arrival position falls within a range over which the projection is formed in the discharge direction, so that downward bending of the front end portion of the discharged document having the first size can be effectively suppressed. As a result, the discharged document can appropriately return upstream in the discharge direction, so that the deterioration of the document alignment can be suppressed.

A third aspect is an aspect according to the second aspect, in which a position of the front end of the document having the first size in a state in which a rear end of the document hits the stopper surface is called a first alignment position, and the first alignment position falls within a range over which the projection is formed in the discharge direction.

When the document having been already stacked has not curled, the document to be discharged next is unlikely to curl, so that the discharged document cannot appropriately return upstream in the discharge direction, which may result in deterioration of the document alignment.

According to the present aspect, in which the position of the front end of the document having the first size in the state in which the rear end of the document hits the stopper surface is called the first alignment position, and the first alignment position falls within the range over which the projection is formed in the discharge direction, the document having been already stacked is likely to curl, so that the document to be discharged next is likely to curl. As a result, the discharged document can appropriately return upstream in the discharge direction, so that the deterioration of the document alignment can be suppressed.

A fourth aspect is an aspect according to the first aspect, in which the second inclining surface is provided with a support configured to support the document, the support being a portion protruding upward from the second inclining surface, and the support is located on opposite sides of the projection in a width direction that is a direction that intersects with the discharge direction.

For a large document, it is preferable that the first inclining surface extends in a downstream region in the discharge direction. However, when a feed tray is provided above the stacking surface, and when the first inclining surface extends in a downstream region in the discharge direction, the distance between the stacking surface and the feed tray decreases, which may cause a decrease in visibility of the discharged document, or a decrease in easiness of picking up the discharged document.

According to the present aspect, in which the second inclining surface is provided with the supports protruding upward from the second inclining surface, and the supports are located on opposite sides of the projection in the width direction, which is a direction that intersects with the discharge direction, a large document can be supported while a decrease in the distance between the stacking surface and the feed tray is suppressed.

In addition, since the supports can increase, in the discharge direction, the range over which the document can curl, the document can appropriately curl, and the downward bending of the front end portion of the discharged document can be effectively suppressed. As a result, the discharged document can appropriately return upstream in the discharge direction, so that the deterioration of the document alignment can be suppressed.

A fifth aspect is an aspect according to the fourth aspect, in which the supports do not protrude upward beyond an imaginary line that is an extension of the first inclining surface extending downstream in the discharge direction when viewed in the width direction.

According to the present aspect, since the supports do not protrude upward beyond the imaginary line, which is an extension of the first inclining surface extending downstream in the discharge direction, when viewed in the width direction, the supports can suppress the decrease in the distance between the stacking surface and the feed tray.

A sixth aspect is an aspect according to the fourth aspect, in which the supports are so formed that the supports each have an upward gradient along the discharge direction, and an upstream end of each of the supports in the discharge direction does not protrude upward beyond the projection.

According to the present aspect, since the supports are so formed that they each have an upward gradient along the discharge direction, the document is likely to return upstream in the discharge direction. In addition, since the upstream end of each of the supports in the discharge direction does not protrude upward beyond the projection, a situation in which the front end of the document is caught when the state in which the front end is supported by the projection transitions to the state in which the front end is supported by the supports can be avoided.

Note that the present aspect may be not only according to the fourth aspect described above but also according to the fifth aspect described above.

A seventh aspect is an aspect according to the first aspect, in which the projection extends to an upstream end of the first inclining surface in the discharge direction.

According to the present aspect, in which the projection extends to the upstream end of the first inclining surface in the discharge direction, already stacked documents are likely to curl, and the document to be discharged next is likely to curl. As a result, the discharged document can appropriately return upstream in the discharge direction, so that the deterioration of the document alignment can be suppressed.

Note that the present aspect may be not only according to the first aspect described above but also according to any of the second to sixth aspects described above.

An eighth aspect is an aspect according to the first aspect, in which the projection is provided on opposite sides of a center position of the discharged document in a width direction that intersects with the discharge direction.

According to the present aspect, the projections are provided on opposite sides of the center position of the discharged document in the width direction, which intersects with the discharge direction, so that the document can appropriately curl.

Note that the present aspect may be not only according to the first aspect described above but also according to any of the second to seventh aspects described above.

A ninth aspect is an aspect according to the eighth aspect, in which the projection is further provided at the center position in the width direction, and the projection provided at the center position protrudes upward beyond the projections provided on opposite sides of the center position.

According to the present aspect, the projection is further provided at the center position in the width direction, and the projection provided at the center position protrudes upward beyond the projections provided on opposite sides of the center position, so that the document can more appropriately curl.

A tenth aspect is an aspect according to the first aspect, in which the discharger includes a first roller and a second roller configured, along with the first roller, to nip the document, and the projection is located above a nip position where the first roller and the second roller nip the document in a vertical direction.

According to the present aspect, since the projection is located above the nip position where the first roller and the second roller nip the document in the vertical direction, the front end of the document discharged by the discharger can first come into contact with the first inclining surface and then come into contact with the projection. The document is therefore likely to have a stabilized posture when discharged, so that the deterioration of the document alignment can be suppressed.

The present disclosure will be specifically described below.

The X-Y-Z coordinate system shown in each figure is an orthogonal coordinate system in which the direction indicated by an arrow is a positive (+) direction and the direction opposite the positive (+) direction is a negative (−) direction. The X-axis direction is the width direction of a document conveyed in an apparatus, and is also the depth direction of the apparatus. In the present embodiment, the −X direction is the frontward direction from the apparatus, and the +X direction is the rearward direction from the apparatus. The Y-axis direction is the width direction of the apparatus, and the +Y direction is the leftward direction and the −Y direction is the rightward direction when the apparatus is viewed in the −X direction. The Z-axis direction is the height direction of the apparatus and the vertical direction.

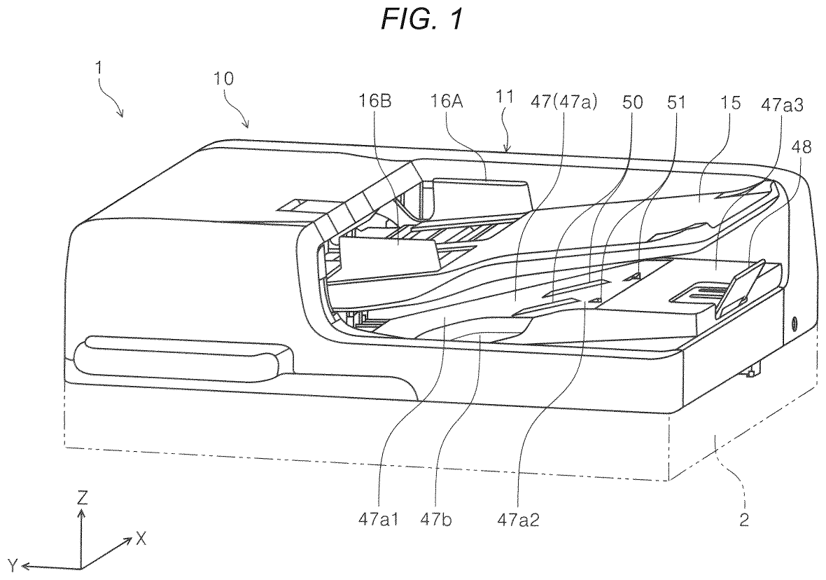

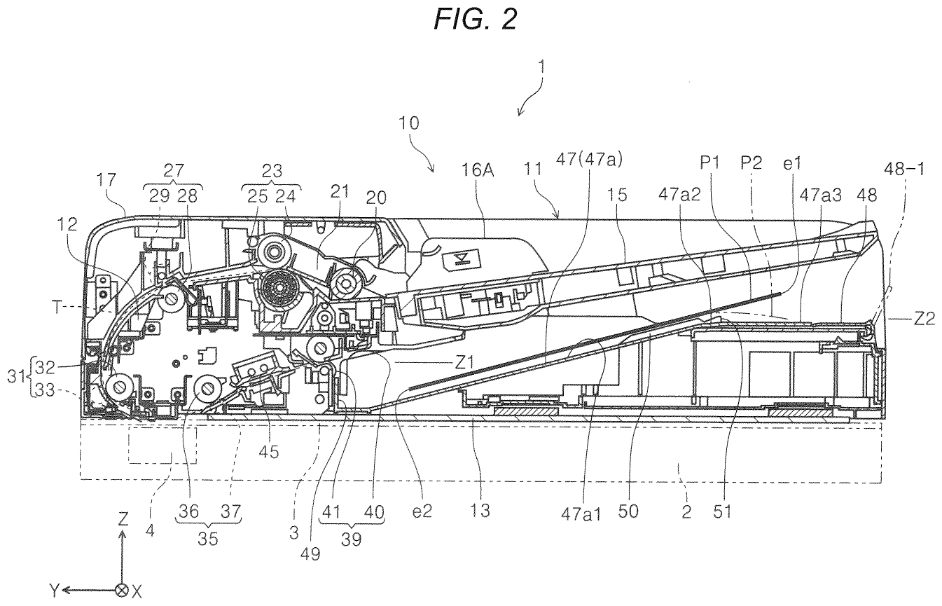

In FIG. 1, a scanner 1, which is an example of an image reading apparatus, includes a document conveyance apparatus 10, which is an example of a document conveyer and is disposed above a scanner unit 2 configured as a flatbed scanner. The document conveyance apparatus 10 pivots via a hinge that is not shown but is provided at an end portion of the document conveyance apparatus 10 in the +X direction and is therefore openable and closable with respect to the scanner unit 2, and opening the document conveyance apparatus 10 exposes and covers a document table glass plate 3 (see FIG. 2), which constitutes an upper portion of the scanner unit 2.

The document conveyance apparatus 10 includes a feed tray 15 and a discharge tray 47 in an apparatus body 11. The feed tray 15 is located above the discharge tray 47.

Documents to be fed are placed in the feed tray 15. The documents are each an example of a medium. Another example of each of the documents is a sheet.

An edge guide 16A, which guides an edge of a placed document that is the edge in the +X direction, is provided in the feed tray 15 at a position in the +X direction in the feed tray 15, and an edge guide 16B, which guides an edge of the placed document that is the edge in the −X direction, is provided at a position in the −X direction in the feed tray 15. The edge guides 16A and 16B are provided so as to be slidable in the direction in which the two edge guides approach each other and in the direction in which the two edge guides move away from each other.

The scanner unit 2 includes the document table glass plate 3, and a first reader 4 is provided below the document table glass plate 3 as shown in FIG. 2 in a way that the first reader 4 is movable along the Y-axis direction.

A pressing mat 13, which presses a document placed on the document table glass plate 3, is provided at the lower surface of the document conveyance apparatus 10. The pressing mat 13 is not provided in a region facing the positive end in the Y-axis direction, a document is conveyed toward the first reader 4, which is stationary in this region, allowing the surface of the document to be read. The document conveyance apparatus 10 accommodates a second reader 45, and the second reader 45 and the first reader 4 can read both sides of the conveyed document. Since the document conveyance apparatus 10 includes the second reader 45, the document conveyance apparatus 10 can be regarded by itself as an example of the image reading apparatus.

A document conveyance path inside the document conveyance apparatus 10 will be further described with reference to FIG. 2.

In FIG. 2, the broken line labeled with reference character T indicates a curved reversing path as the document conveyance path in the document conveyance apparatus 10. The curved reversing path T is a path from a separation roller pair 23 to a fourth conveyance roller pair 39. Note in the present specification that a roller pair means a pair of rollers disposed to face each other in a way that the rollers sandwich the curved reversing path T.

The documents placed in the feed tray 15 are each sent by a pickup roller 20. The pickup roller 20 is provided at a position where the pickup roller 20 faces a +Y-direction end region of each of the documents placed in the feed tray 15.

The pickup roller 20 driven by a motor that is not shown is supported by a roller support member 21. The roller support member 21 is swingably provided coaxially with a feed roller 24, and swings to move the pickup roller 20 back and forth with respect to the document.

The separation roller pair 23 is provided downstream from the pickup roller 20. The separation roller pair 23 is configured with the feed roller 24 driven by a motor that is not shown, and a separation roller 25, to which rotational resistance has been imparted. A torque limiter that is not shown imparts rotation resistance to the separation roller 25, and the document sent by the pickup roller 20 is separated from the other documents by the effect of the separation roller 25 and is fed downstream.

A first conveyance roller pair 27 is provided downstream from the separation roller pair 23. The first conveyance roller pair 27 is configured with a driving roller 28, which is driven by a motor that is not shown, and a driven roller 29, which is rotatably driven.

The document is curved downward at a position downstream from the first conveyance roller pair 27. A second conveyance roller pair 31 is provided downstream from the first conveyance roller pair 27. In the curved reversing path T, the second conveyance roller pair 31 nips and conveys the document at a position where the surface of the document facing downward is changed to face upward, that is, at a position downstream from the position farthest in the +Y direction in the curved reversing path T.

The second conveyance roller pair 31 is configured with a driving roller 32, which is driven by a motor that is not shown, and a driven roller 33, which is rotatably driven.

The document sent from the feed tray 15 is curved downward by the curved reversing path T, and then reversed to travel in the direction opposite the direction in which the document is sent from the feed tray 15, that is, in the −Y direction. The reversed document passes through a region facing the first reader 4, which is stationary at the position shown in FIG. 2, is read, and arrives at a third conveyance roller pair 35. The third conveyance roller pair 35 is configured with a driving roller 36, which is driven by a motor that is not shown, and a driven roller 37, which is rotatably driven.

The document fed by the third conveyance roller pair 35 passes through a region facing the second reader 45, is read, and reaches the fourth conveyance roller pair 39. The fourth conveyance roller pair 39 is configured with a driving roller 40, which is driven by a motor that is not shown, and a driven roller 41, which is rotatably driven. The document is discharged to the discharge tray 47 by the fourth conveyance roller pair 39. The discharge tray 47 has a stacking surface 47a, at which the discharged document is stacked. Note that a recess 47b (see FIG. 1) is provided in a −X-direction portion of the stacking surface 47a to facilitate removal of the stacked document.

The fourth conveyance roller pair 39 is an example of a discharger that discharges a read document. The driving roller 40 is an example of a first roller, and the driven roller 41 is an example of a second roller that along with the first roller nips a medium.

The discharge tray 47 is an example of a stacker that forms the stacking surface 47a, on which the document discharged by the fourth conveyance roller pair 39 is stacked.

In an exact sense, the direction in which the document is discharged by the fourth conveyance roller pair 39 includes a very small amount of +Z-direction component in addition to the −Y direction-component, but the −Y direction is hereinafter defined as the document discharge direction for convenience. Furthermore, in the following description, downstream in the discharge direction means the −Y direction, and upstream in the discharge direction means the +Y direction.

A stopper 48 is provided at a most downstream position in the discharge direction at the stacking surface 47a. The stopper 48, which pivots, is provided in a way that it can take a used state in which it is used, and a stored state in which it is stored. The stopper 48 shown in FIG. 1 and the stopper 48 indicated by the two-dot chain line and labeled with reference character 48-1 in FIG. 2 is in the used state. The stopper 48 indicated by the solid line in FIG. 2 is in the stored state.

In the aforementioned process of conveying a document along the curved reversing path T, the upper surface of the document placed in the feed tray 15 is read by the first reader 4, and the lower surface of the document placed in the feed tray 15 is read by the second reader 45.

In the present embodiment, the second reader 45 and the first reader 4 are each configured with a contact-type image sensor module (CISM).

The stacking surface 47a and projections 50 will next be described.

The stacking surface 47a has a first inclining surface 47a1, a second inclining surface 47a2, and a horizontal surface 47a3 along the discharge direction.

The first inclining surface 47a1 is a surface having an upward gradient along the discharge direction, and is a planar surface as a whole.

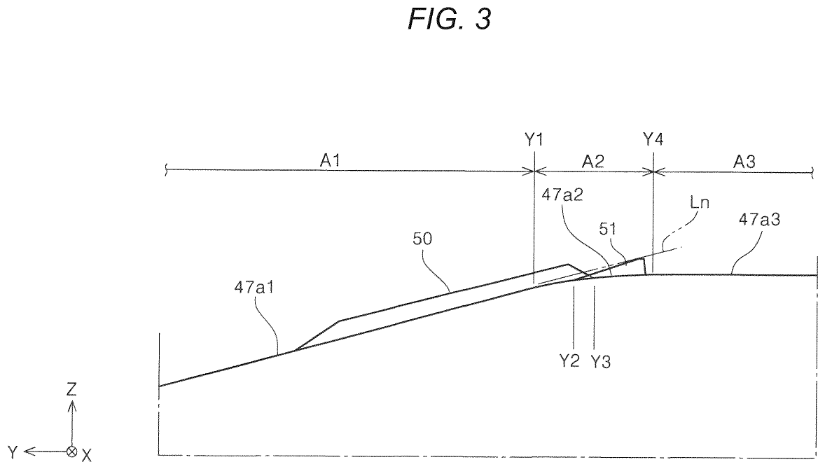

The second inclining surface 47a2 is located downstream from the first inclining surface 47a1 in the discharge direction, and is so formed that it has a smaller upward gradient along the discharge direction than the upward gradient of the first inclining surface 47a1. In the present embodiment, the second inclining surface 47a2 is formed as a curved surface that is gently convex upward, as shown in FIG. 3. Note, however, that the second inclining surface 47a2 may be a planar surface.

The horizontal surface 47a3 is a surface parallel to the X-Y plane and is a planar surface.

In FIG. 3, a region A1 is the range of the first inclining surface 47a1 in the discharge direction, a region A2 is the range of the second inclining surface 47a2 in the discharge direction, and a region A3 is the range of the horizontal surface 47a3 in the discharge direction.

In FIG. 3, a position Y1 is the position of the boundary between the first inclining surface 47a1 and the second inclining surface 47a2. The first inclining surface 47a1 has a fixed gradient up to the position Y1 along the discharge direction. The gradient changes in the region beyond the position Y1.

A position Y4 is the position of the boundary between the second inclining surface 47a2 and the horizontal surface 47a3. The second inclining surface 47a2 has an upward gradient up to the position Y4 along the discharge direction. The upward gradient ends at the position Y4.

When a document is discharged onto the thus configured stacking surface 47a, the document travels downstream in the discharge direction on the stacking surface 47a due to the momentum that the document has when it is discharged, and then slides back on the stacking surface 47a or on a document having been already stacked to return upstream in the discharge direction. In FIG. 2, a document labeled with reference character P1 is a document to be discharged onto the stacking surface 47a for the first time, and shows an example of a state in which the document travels to a most downstream position in the discharge direction on the stacking surface 47a due to the momentum that the document has when it is discharged. From the state described above, the document P1 slides back on the stacking surface 47a to return upstream in the discharge direction, and a rear end e2 of the document P1 hits a stopper surface 49.

When a document has already been discharged onto the stacking surface 47a, a document to be discharged next travels downstream in the discharge direction while being in contact with the already stacked document. The document then slides back on the already stacked document to return upstream in the discharge direction, and the rear end e2 of the document hits the stopper surface 49.

The stacking surface 47a has the first inclining surface 47a1 and the second inclining surface 47a2 having an upward gradient smaller than that of the first inclining surface 47a1. Therefore, when a front end e1 of the discharged document sticks downstream in the discharge direction out of the first inclining surface 47a1, a front end portion of the discharged document bends downward, and is therefore unlikely to return upstream in the discharge direction, which may result in deterioration of document alignment. In FIG. 2, the two-dot chain line labeled with reference character P2 indicates a document having a front end portion bending downward. The deterioration of the document alignment occurs due to the fact that the rear end e2 of the document cannot return to the stopper surface 49.

To avoid the problem described above, the projections 50 are provided at the stacking surface 47a in the present embodiment. The projections 50 protrude upward from the stacking surface 47a and extend along the discharge direction. The projections 50 cause the document to curl in a way that the document projects upward when viewed from the discharge direction. In the present embodiment, the projections 50 are each formed in the shape of a rib. Furthermore, in the present embodiment, the top portion of each of the projections 50 is so formed that the top portion has an upward gradient along the discharge direction and is parallel to the first inclining surface 47a1.

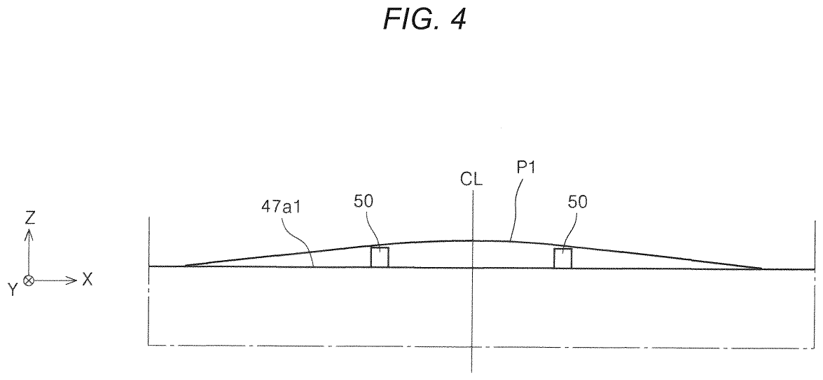

FIG. 4 diagrammatically shows the state in which the projections 50 cause the document P1 to curl. Reference character CL denotes the center position of the document P1 in the width direction.

In the present embodiment, the projections 50 are provided on opposite sides of the center position CL, one on each side. The document P1 can thus appropriately curl.

The projections 50 are so formed that they each have an upward gradient along the discharge direction, and extend throughout the first inclining surface 47a1 and the second inclining surface 47a2, as shown in FIG. 3. The following effects and advantages are thus provided:

The stacking surface 47a has the first inclining surface 47a1 and the second inclining surface 47a2 having an upward gradient smaller than that of the first inclining surface 47a1. Therefore, when the front end e1 of a discharged document sticks downstream in the discharge direction out of the first inclining surface 47a1, a front end portion of the discharged document bends downward, so that the document is unlikely to return upstream in the discharge direction, which may result in deterioration of the document alignment as described above.

However, the stacking surface 47a is provided with the projections 50 protruding upward from the stacking surface 47a and extending along the discharge direction. The projections 50 cause the document to curl in a way that the document projects upward when viewed in the discharge direction, as shown in FIG. 4. The projections 50 are so formed that they each have an upward gradient along the discharge direction, and extend throughout the first inclining surface 47a1 and the second inclining surface 47a2. As a result, even when the front end of the discharged document sticks downstream in the discharge direction out of the first inclining surface 47a1, the document can appropriately curl as shown in FIG. 4, so that the downward bending of the front end portion of the discharged document can be effectively suppressed. As a result, the discharged document can appropriately return upstream in the discharge direction, so that the deterioration of the document alignment can be suppressed.

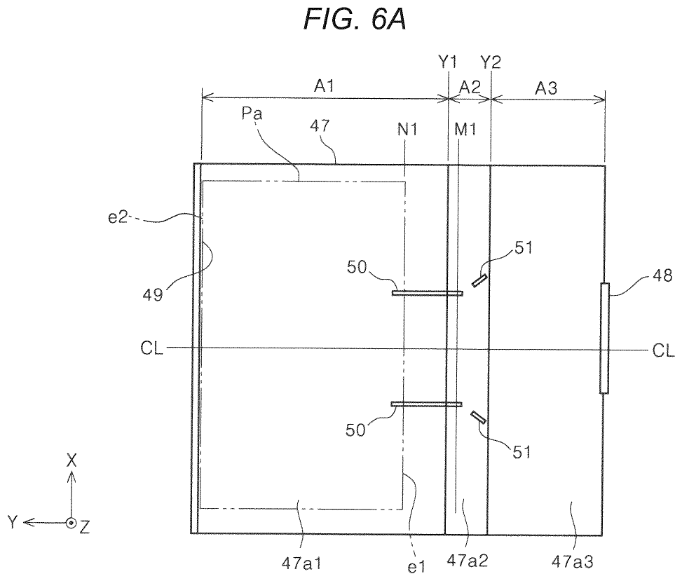

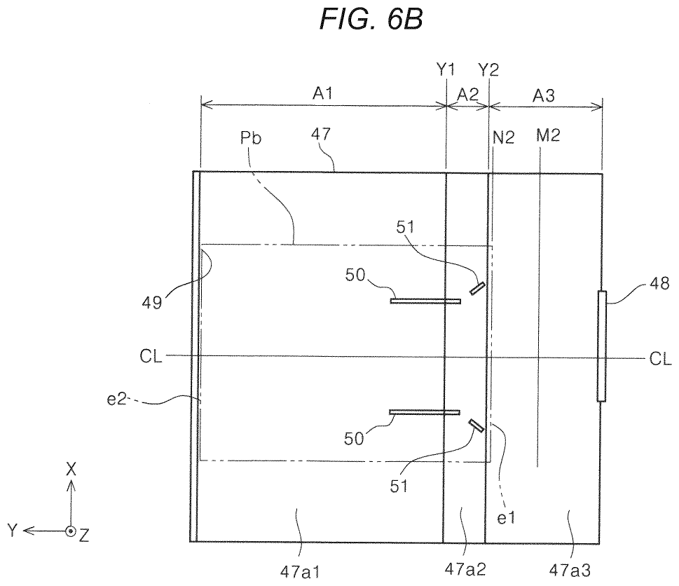

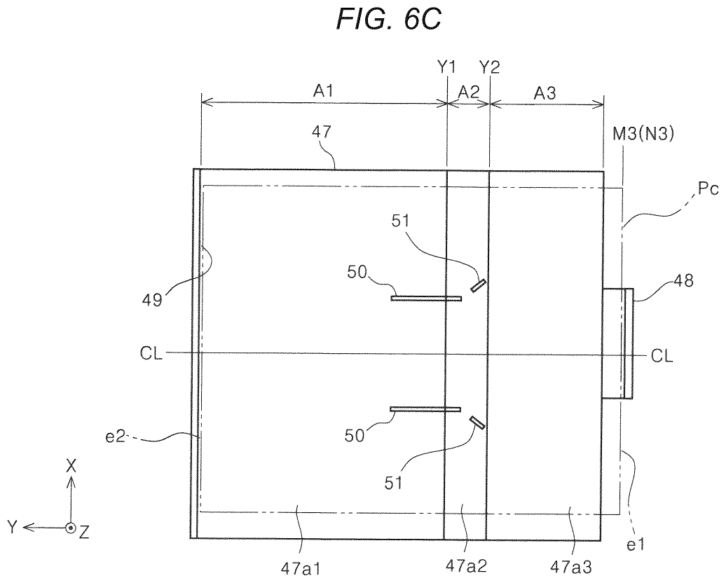

Next, FIG. 6A shows the positional relationship between the projections 50 and a document Pa having a first size at the time when the document Pa is discharged. The situation shown in FIG. 6A is, for example, a case where the document Pa is a A4-size sheet and the widthwise direction thereof is along the discharge direction. The state of the document Pa indicated by the two-dot chain line shows that the document Pa is discharged, and then returns upstream in the discharge direction, and the rear end e2 of the document Pa hits the stopper surface 49.

A position M1 is a position where the front end e1 of the document Pa arrives at the most downstream point due to the momentum that the document Pa has when the document Pa is discharged, and this point is hereinafter referred to as a first arrival position M1.

The first arrival position M1 falls within the range over which the projections 50 are formed in the discharge direction, as shown in FIG. 6A.

The downward bending of a front end portion of the discharged document Pa can therefore be effectively suppressed. As a result, the discharged document Pa can appropriately return upstream in the discharge direction, so that the deterioration of the document alignment can be suppressed.

Note that the document Pa is not necessarily an A4-size sheet or so positioned that the widthwise direction thereof is along the discharge direction, and it is needless to say that the document pa may have other sizes and orientations.

Furthermore, the position of the front end of the document Pa in the state in which the rear end e2 of the document Pa hits the stopper surface 49 is called a first alignment position N1, and the first alignment position N1 falls within the range over which the projections 50 are formed in the discharge direction. The following effects and advantages are thus provided:

When the document Pa having been already stacked has not curled, the document Pa to be discharged next is unlikely to curl, so that the discharged document Pa cannot appropriately return upstream in the discharge direction, which may result in deterioration of the document alignment.

However, since the first alignment position N1 falls within the range over which the projections 50 are formed in the discharge direction as described above, the document Pa having been already stacked is likely to curl, so that the document Pa to be discharged next is likely to curl. As a result, the discharged document Pa can appropriately return upstream in the discharge direction, so that the deterioration of the document alignment can be suppressed.

Note also in this case that the document Pa is not necessarily an A4-size sheet or so positioned that the widthwise direction thereof is along the discharge direction, and it is needless to say that the document Pa may have other sizes and orientations.

Next, a document Pb shown in FIG. 6B shows a case where the document Pb is an A4-size sheet and the lengthwise direction thereof is along the discharge direction. The state of the document Pb indicated by the two-dot chain line shows that the document Pb is discharged, and then returns upstream in the discharge direction, and the rear end e2 of the document Pb hits the stopper surface 49.

A position M2 is the first arrival position, where the front end e1 of the document Pb arrives at the most downstream point due to the momentum that the document Pb has when the document Pb is discharged.

A position N2 is the position of the front end of the document Pb in the state in which the rear end e2 of the document Pb hits the stopper surface 49, that is, the first alignment position.

In the present embodiment, the first arrival position M2 does not fall within the range over which the projections 50 are formed in the discharge direction, but the downward bending of a front end portion of the document Pb is suppressed by the curl formation effect of the projections 50.

Next, a document Pc shown in FIG. 6C shows a case where the document Pc is an A3-size sheet and the lengthwise direction thereof is along the discharge direction. The document Pc indicated by the two-dot chain line is in a state where the rear end e2 of the document Pc is in contact with the stopper surface 49.

A position M3 is a position where the front end e1 of the document Pc arrives at the most downstream point when the document Pc is discharged. In the present embodiment, the document Pc, which is an A3-size sheet, has a large size and thus is unlikely to stick out in the discharge direction. Therefore, the first arrival position M3 substantially coincides with a first alignment position N3, which is the position of the front end of the document Pc in a state in which the rear end e2 of the document Pc is in contact with the stopper surface 49.

The stopper 48 is slidable along the discharge direction. Therefore, even when the front end e1 of the document Pc sticks in the discharge direction out of the horizontal surface 47a3, further sticking out of the front end e1 can be restricted.

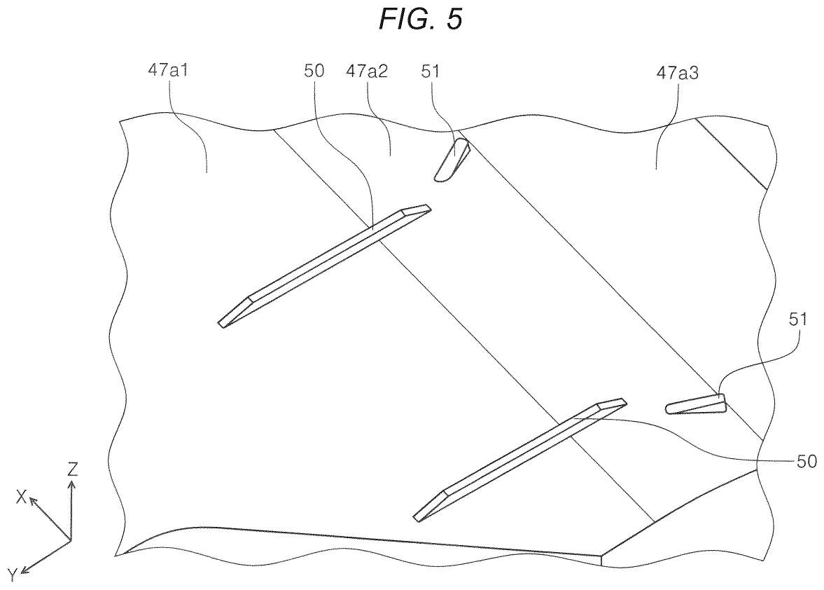

Supports 51 will next be described. In the present embodiment, the supports 51, which are portions protruding upward from the second inclining surface 47a2 and can support a document, are provided at the second inclining surface 47a2, as shown in FIGS. 3 and 5. In the present embodiment, the supports 51 are each formed in the shape of a rib. Furthermore, in the present embodiment, the supports 51 are each so formed that the top portion thereof has an upward gradient. Moreover, in the present embodiment, the supports 51 are each so formed that it extends outward in the width direction from the center position CL as it extends along the discharge direction.

The supports 51 are located on opposite sides of the projections 50 in the width direction. The following effects and advantages are thus provided:

For a large document, it is preferable that the first inclining surface 47a1 extends in a downstream region in the discharge direction. However, when the feed tray 15 is provided above the stacking surface 47a, and when the first inclining surface 47a1 extends in a downstream region in the discharge direction, the distance between the stacking surface 47a and the feed tray 15, specifically, the distance in the Z-axis direction decreases, which may cause a decrease in visibility of a discharged document, or a decrease in easiness of picking up a discharged document.

According to the present embodiment, the supports 51 protruding upward from the second inclining surface 47a2 are provided at the second inclining surface 47a2, and the supports 51 are located on opposite sides of the projections 50 in the width direction, which is a direction that intersects with the discharge direction. The configuration described above allows supporting a large document while suppressing a decrease in the distance between the stacking surface 47a and the feed tray 15.

In addition, since the supports 51 can increase, in the discharge direction, the range over which a document can curl, the document can appropriately curl (refer to FIG. 4), and the downward bending of a front end portion of a discharged document can be effectively suppressed. As a result, the discharged document can appropriately return upstream in the discharge direction, so that the deterioration of the document alignment can be suppressed.

Note, however, that the supports 51 may be omitted.

In the present embodiment, the supports 51 do not protrude upward beyond an imaginary line Ln, which is an extension of the first inclining surface 47a1 extending downstream in the discharge direction, when viewed in the width direction, as shown in FIG. 3.

The thus configured supports 51 can suppress the decrease in the distance between the stacking surface 47a and the feed tray 15.

Note that the supports 51 may protrude upward beyond the imaginary line Ln.

Furthermore, in the present embodiment, the supports 51 are so formed that they each have an upward gradient along the discharge direction, and the upstream end of each of the supports 51 in the discharge direction does not protrude upward beyond the projections 50. In FIG. 3, a position Y2 is a position of an upstream end of each of the supports 51 in the discharge direction. A position Y3 is the position of the downstream end of each of the projections 50 in the discharge direction. At the position Y2, the supports 51 do not protrude upward beyond the projections 50.

Since the supports 51 are so formed that they each have an upward gradient along the discharge direction as described above, a document is likely to return upstream in the discharge direction. In addition, since the upstream end of each of the supports 51 in the discharge direction does not protrude upward beyond the projections 50, a situation in which the front end e1 of a document is caught when the state in which the front end e1 is supported by the projections 50 transitions to the state in which the front end e1 is supported by the supports 51 can be avoided.

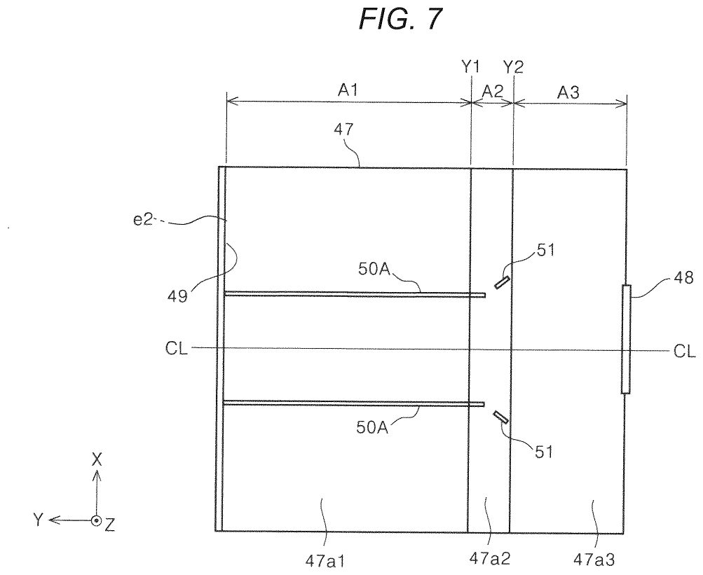

The projections 50 may extend to the upstream end of the first inclining surface 47a1 in the discharge direction, as indicated by reference character 50A in FIG. 7. As described above, in the configuration in which the projections 50A extend to the upstream end of the first inclining surface 47a1 in the discharge direction, already stacked documents are likely to curl, and the document to be discharged next is likely to curl. As a result, the discharged document can appropriately return upstream in the discharge direction, so that the deterioration of the document alignment can be suppressed.

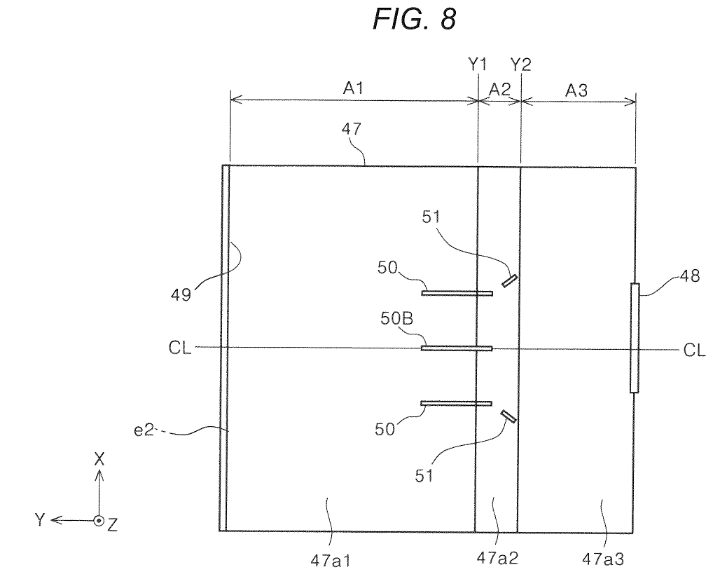

A projection may be further provided at the center position CL in the width direction. FIG. 8 shows such an embodiment, and reference character 50B denotes a projection provided at the center position CL.

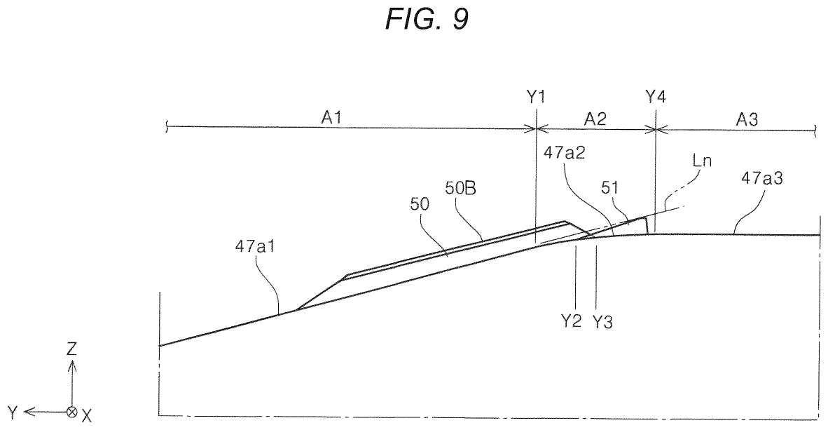

The projection 50B protrudes upward beyond the projections 50 provided on opposite sides of the center position CL, as shown in FIG. 9. According to the configuration described above, a medium can curl more appropriately.

The projections 50 are located above a nip position Z1, where a document is nipped by the fourth conveyance roller pair 39 in the vertical direction, as shown in FIG. 2. The front end of the document discharged by the fourth conveyance roller pair 39 can therefore first come into contact with the first inclining surface 47a1, and then come into contact with the projections 50. The document is therefore likely to have a stabilized posture when discharged, so that the deterioration of the document alignment can be suppressed.

Other features, variations, and the like of the embodiment described above will be described below.

When the curvature of the curl (see FIG. 4) of a document becomes too large, the rigidity of the document becomes too high, so that there is a concern that a discharged document pushes an already stacked document out in the discharge direction, which may deteriorate the document alignment. In the embodiment described above, since the two projections 50 are provided along the width direction, the curvature of the curl of a document becomes appropriate, so that the problem described above can be suppressed.

Note, however, that three or more projections 50 may be provided along the width direction as described with reference to FIG. 8, or only one projection 50 may be provided. The same holds true for the supports 51.

The projections 50 may be provided in a way that they are movable in the width direction so as to adapt to the size and orientation of a medium to be discharged. The same holds true for the supports 51. In this case, it is also preferable to add marks, document sizes, document orientations, and the like to the stacking surface 47a so that appropriate positions of the projections 50 and the supports 51 are visually recognizable.

In the present embodiment, the projections 50 and the supports 51 partially overlap with each other when viewed in the width direction. Note, however, that the projections 50 and the supports 51 may not overlap with each other when viewed from the width direction.

In the present embodiment, the first inclining surface 47a1 and the second inclining surface 47a2 are continuously provided along the discharge direction. Note, however, that another surface may be interposed between the first inclining surface 47a1 and the second inclining surface 47a2.

In the present embodiment, the projections 50 and the stopper 48 overlap with each other in the vertical direction, as shown in FIG. 2. In FIG. 2, reference character Z2 denotes the position of the highest point of the projections 50 in the vertical direction. As is clear from the position Z2, the projections 50 and the stopper 48 overlap with each other in the vertical direction.

In the present embodiment, the stopper 48 is located between the two supports 51 in the width direction, as shown in FIG. 6A.

In the present embodiment, the stopper 48 has an upward gradient along the discharge direction in the used state. The upward gradient of the stopper 48 is greater than the upward gradient of the first inclining surface 47a1. The thus configured stopper 48 can preferably suppress sticking out of a document in the discharge direction.

In the present embodiment, the stopper 48 is located further downstream from the position where the front end of a document having any size arrives at the most downstream point due to the momentum the document has when the document is discharged.

The present disclosure is not limited to the embodiments described above. Various variations are conceivable within the scope of the disclosure described in the claims, and it is needless to say that the variations also fall within the scope of the present disclosure.

The aforementioned embodiments have been described with reference to the case where the document conveyance apparatus 10 is used in the scanner 1, which is an example of the image reading apparatus, and the document conveyance apparatus 10 can also be used as a medium conveyance apparatus in a recording apparatus including a recording unit that performs recording on a medium.

What is claimed is:

1. An image reading apparatus comprising:
a reader configured to read an image of a document; and
a document conveyer configured to convey the document to the reader,
wherein the document conveyer includes
a discharger configured to discharge the document read by the reader, and
a stacker configured to form a stacking surface on which the document discharged by the discharger is stacked,
the stacking surface has
a first inclining surface having an upward gradient along a discharge direction in which the document is discharged, and
a second inclining surface located downstream from the first inclining surface in the discharge direction and having an upward gradient smaller than the upward gradient of the first inclining surface along the discharge direction,
a stopper surface that a rear end of the document hits is provided upstream from the first inclining surface in the discharge direction,
the stacking surface is provided with a projection protruding upward from the stacking surface and extending along the discharge direction, and
the projection is so formed that the projection has an upward gradient along the discharge direction and extends throughout the first inclining surface and the second inclining surface.

2. The image reading apparatus according to claim 1, wherein
a position at which a front end of a document having a first size arrives at a most downstream point in the discharge direction when the document is discharged is called a first arrival position, and the first arrival position falls within a range over which the projection is formed in the discharge direction.

3. The image reading apparatus according to claim 2, wherein
a position of the front end of the document having the first size in a state in which a rear end of the document hits the stopper surface is called a first alignment position, and the first alignment position falls within a range over which the projection is formed in the discharge direction.

4. The image reading apparatus according to claim 1, wherein
the second inclining surface is provided with a support configured to support the document, the support being a portion protruding upward from the second inclining surface, and
the support is located on opposite sides of the projection in a width direction that is a direction that intersects with the discharge direction.

5. The image reading apparatus according to claim 4, wherein
the supports do not protrude upward beyond an imaginary line that is an extension of the first inclining surface extending downstream in the discharge direction when viewed in the width direction.

6. The image reading apparatus according to claim 4, wherein
the supports are so formed that the supports each have an upward gradient along the discharge direction, and
an upstream end of each of the supports in the discharge direction does not protrude upward beyond the projection.

7. The image reading apparatus according to claim 1, wherein
the projection extends to an upstream end of the first inclining surface in the discharge direction.

8. The image reading apparatus according to claim 1, wherein
the projection is provided on opposite sides of a center position of the discharged document in a width direction that intersects with the discharge direction.

9. The image reading apparatus according to claim 8, wherein
the projection is further provided at the center position in the width direction, and
the projection provided at the center position protrudes upward beyond the projections provided on opposite sides of the center position.

10. The image reading apparatus according to claim 1, wherein
the discharger includes a first roller and a second roller configured, along with the first roller, to nip the document, and
the projection is located above a nip position where the first roller and the second roller nip the document in a vertical direction.
